(19) United States
(12) Patent Application Publication
(10) Pub. No.: US 2007/0088563 A1
(43) Pub. Date: Apr. 19, 2007

(54) System and method for managing a continuing education program

(75) Inventors: Michael J. Nardotti JR., Woodbridge, VA (US); Linda L. Hardenstein, Germantown, MD (US); Lorna J. Shingleton, Mechanicsville, MD (US); Qun Yue, Ashburn, VA (US)

Correspondence Address: PATTON BOGGS, 1660 LINCOLN ST, SUITE 2050, DENVER, CO, 80264, US

(73) Assignee: Patton Boggs LLP, Denver, CO (US)

(21) Appl. No.: 11/253,080

(22) Filed: Oct. 17, 2005

(51) Int. Cl. G06Q 99/00

(52) U.S. Cl. 705/1

(57) ABSTRACT

A system and method for managing a continuing education program. A request submission to attend a CLE course may be sent to a supervisor to be approved or disapproved. The method may include storing on an electronic storage device the financial information related to a budget for the continuing education program and continuing education information including a course identifier. The method further includes receiving estimated attendance costs for attending the continuing education program and comparing the estimated attendance costs to the financial information to determine whether the estimated attendance costs are within a budget for a person to attend the continuing education program.

### BACKGROUND OF THE INVENTION

The law profession is noble in its goal to maintain the skills and knowledge of practicing lawyers at high proficiency levels. One way that the legal profession regulates practicing attorneys is by requiring members of the bar to take a required number of continuing legal education (CLE) courses to reach a certain number of credit hours. CLE credit hours are typically achieved by attending seminar courses taught by other members ofthe legal profession, teaching seminar courses, watching previously recorded courses, conducting self-study hours, and other approved forms of continuing legal education. The requirements for CLE vary from state to state as set by each state bar. The amount and type of CLE credits required by each state bar may vary significantly. Currently, as reported by the American Bar Association (ABA), 40 state bars have mandatory CLE requirements in order for attorneys to practice law in the individual states.

To illustrate the different state bar CLE requirements, Massachusetts does not require any CLE credit hours and Texas requires 15 CLE credit hours per year. Table I provides a few exemplary state CLE requirements showing total CLE requirements and specific CLE credit allocations. As shown, the CLE requirements can be quite complex, thereby being a challenge for each attorney in the states to meet the CLE credit requirements. States that have such requirements may enforce the CLE requirements by reprimand, suspension of license to practice, or even disbarment. Therefore, it is important for attorneys to maintain their required annual CLE credits.

TABLE I
Exemplary CLE Credit Requirements for Select States

| | CLE CREDIT REQUIREMENTS | | |
|---|---|---|---|
| STATE | Total Credits | Period | Specific Credits |
| California | 25 hrs | 3 years | 19 General |
| | | | 4 Legal Ethics |
| | | | 1 Substance Abuse |
| | | | 1 Elimination of Bias |
| Louisiana | 12.5 hrs. | 1 year | 10.5 General |
| | | | 1.0 Ethics |
| | | | 1.0 Professionalism |
| | | | 2.5 CLE (1^{st} year attorneys) |
| | | | 8.0 Ethics, Professionalism, |
| | | | Law Practice Mgmt. |
| | | | (first year attorneys) |
| Texas | 15.0 | 1 year | 12.0 General |
| | | | 3.0 Ethics |
| | | | (1.0 self-study optional) |

In addition to the importance for individual attorneys to maintain their annual CLE credit requirements, law firms that have attorneys who do not fulfill their annual CLE credit requirements may also face problems, including public reprimand and fines. It is, therefore, in the best interest of a law firm, large or small, to be diligent in ensuring that each attorney in the firm fulfills his or her annual CLE credit obligations.

One way that larger law firms have attempted to ensure CLE credit requirement compliance by each of its attorneys is to hire a CLE coordinator whose job is to find CLE course opportunities, coordinate attorneys to attend the CLE courses, monitor CLE credits for each attorney, and manage a CLE budget. Because of the CLE requirements in different states and law firm policies, the CLE coordinator, particularly for a multi-state law firm, may be faced with a very difficult job.

Because of the complexity of managing CLE requirements for individual attorneys, a number of online CLE tracking systems have been developed. These conventional CLE tracking systems enable attorneys to link to sponsors and CLE course providers to sign up to take particular CLE courses. These CLE tracking systems further enable the attorneys to manage and keep track of the number of CLE credits with respect to the CLE credit requirements in particular states. While this serves to be useful for attorneys to manage their CLE requirements and CLE course providers to promote their CLE courses, the CLE tracking systems available provide little more than what is possible with a paper and pen from a law firm management's point of view. The conventional CLE tracking systems may be Internet based and may be a subscription service for one or both of the CLE course providers and attorneys. One CLE tracking system enables only the CLE course providers to enter information into the system for course work that has been completed by the individual attorneys to prevent falsification of course work completed. Other CLE tracking systems may be more sophisticated by providing online educational materials that include testing for comprehension to ensure that the student actually watched or participated in the courses. Course work that is completed may thereby be stored on the online system. Still yet, to make CLE course training more accessible, some CLE training systems offer hand-held devices to enable attorneys to download and participate in online CLE training courses. One CLE training system even offers award programs for participating in particular online CLE courses.

While conventional CLE tracking systems provide for easier ways to monitor CLE credits and access CLE courses, these CLE tracking systems are still limited in their functionality for law firms to manage individual attorneys based on law firm economics.

### SUMMARY OF THE INVENTION

To provide CLE training management for a company or firm that is useful for management purposes, the principles of the present invention may be integrated into a CLE training system to improve a law firm's ability and efficiency in assisting attorneys in identifying and locating CLE training opportunities, approving the CLE training by firm management, and maintaining CLE training budgets. The CLE training system may be integrated into a network accessible to attorneys and management of a law firm, for example. The system may allow a CLE coordinator to post CLE training opportunities for attorneys to browse, select, and request approval to attend. An administrator may receive the request via the network and approve or reject the CLE training request. The attorney may submit expenses using the system for reimbursement. The system may also provide for, or be in communication with, an accounting system to enable the CLE coordinator to manage a CLE training budget.

One embodiment of the principles of the present invention may include a product and method for administering and tracking an attorney training program. The product may include instructions to direct a processing unit to receive a request for a course list; in response to the request, display a list of available courses; and receive a training form input that a training request form is to be provided. In response to the training form input, the processing unit may display a training request screen. The processing unit may be further directed to receive and store a training request input via the training request screen; responsive to the training request input, send an electronic approval request to an administrative person; display an approval screen, including the training request input on an administrator display; receive and store an approval/disapproval input; and communicate a message related to the approval/disapproval input. The product may further include a media readable by the processing unit that stores the instructions.

Another embodiment may include a method for managing a continuing education program. The method may include storing financial information related to a budget for the continuing education program and continuing education information including a course identifier on an electronic storage device. The method further includes receiving estimated attendance costs for attending the continuing education program and comparing the estimated attendance costs to the financial information to determine whether the estimated attendance costs are within a budget for a person to attend the continuing education program.

### BRIEF DESCRIPTION OF THE DRAWINGS

FIG. 1 is a map that includes an exemplary law firm having multiple offices, each in a different state;

FIG. 2 is a block diagram of an exemplary network of computers utilized by a law firm having multiple offices, such as that shown in FIG. 1;

FIG. 3 is a block diagram showing software that may be executed by a processor of a server, such as one shown in FIG. 2, for interfacing a CLE management system with an accounting system utilized by a law firm;

FIG. 4 is a screen shot of an exemplary user interface for a user to view and select outside CLE training opportunities;

FIGS. 5-9 are screen shots of an exemplary user interface representing a training form or sheet for a user to request outside CLE training opportunities;

FIG. 10 is a block diagram describing an exemplary process for enabling attorneys to submit training requests to management to attend a CLE course; and

FIG. 11 is a block diagram of an exemplary process for managing a continuing education program.

### DETAILED DESCRIPTION OF THE PRESENT INVENTION

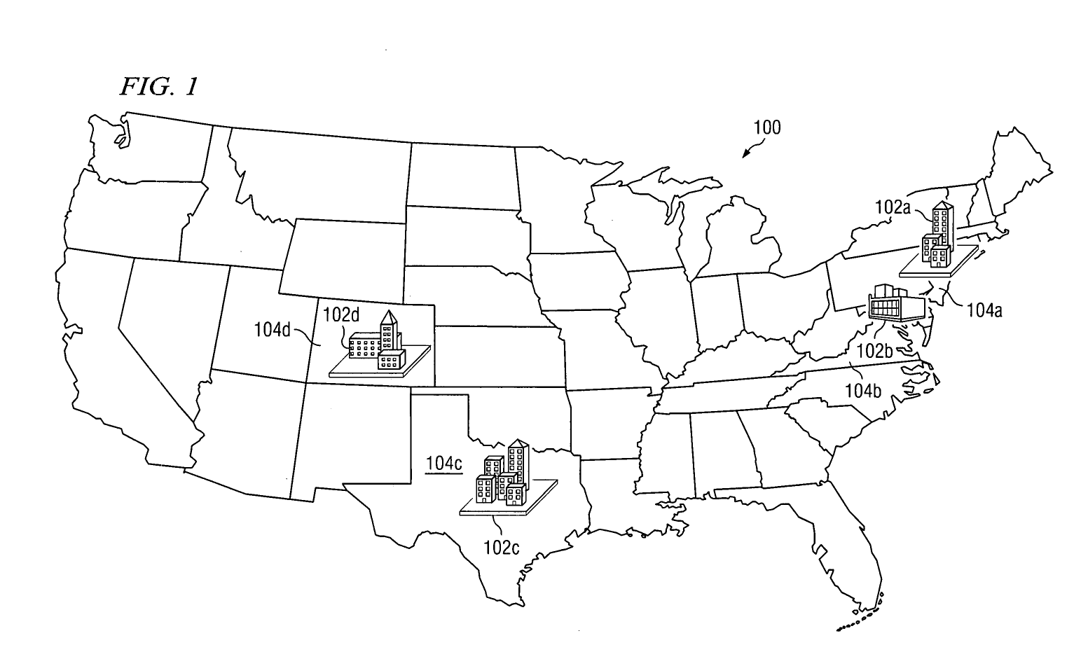

FIG. 1 is a map 100 that includes an exemplary law firm having multiple offices 102a-102b (collectively 102), each in a different state 104a-104d (collectively 104). The law firm maybe headquartered in the office 102a located in Washington, D.C., while satellite offices ofthe law firm may be located in different states, such as Virginia, Texas, and Colorado, as shown. The main office 102a may include an administration composed of attorneys or others that manage the law firm. The administration may include a CEO, management committee, human resources administration, marketing administration, CLE administration, and other administration functions. The CLE administration may include an administrator or coordinator whose responsibility is to provide CLE training opportunities to attorneys in the law firm and ensure that each attorney fulfills his or her CLE requirements for the particular state(s) in which he or she is licensed to practice.

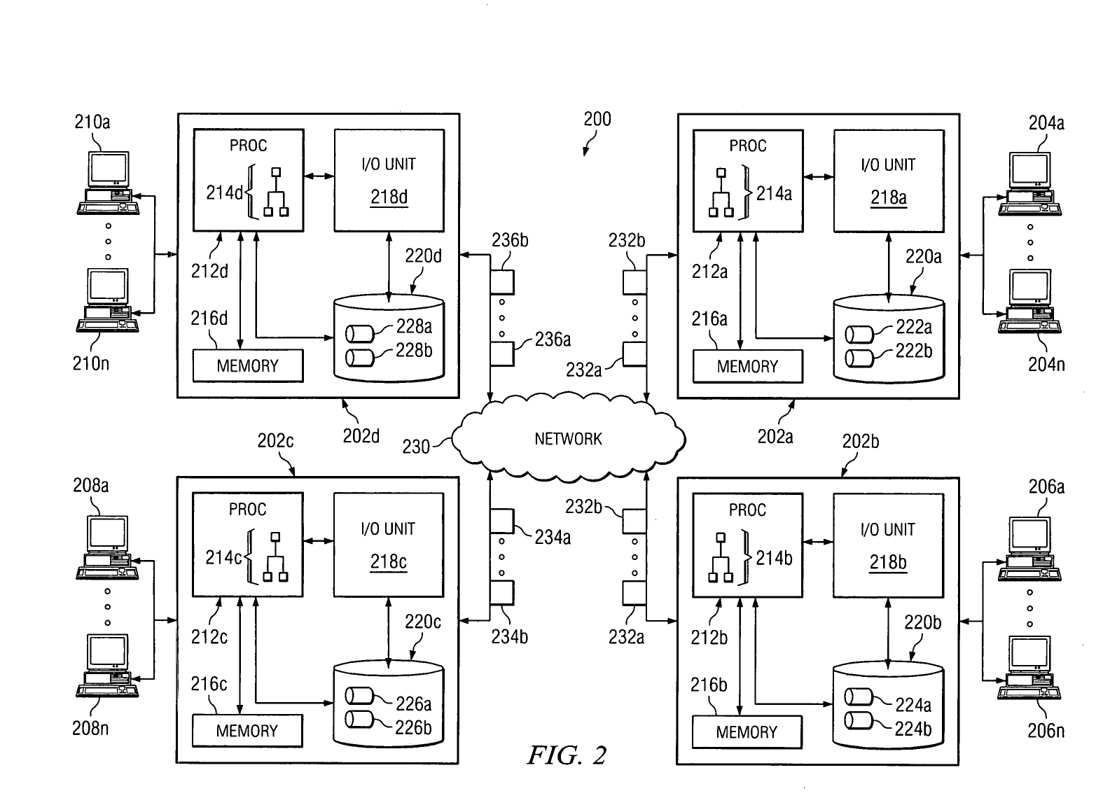

FIG. 2 is a block diagram of an exemplary network of computers 200 utilized by a law firm having multiple offices, such as that shown in FIG. 1. Each law office may utilize a server 202a, 202b, 202c, and 202d (collectively 202), respectively. The servers 202 may host personal computers 204a-204n, 206a-206n, 208a-208n, and 210a-210n, respectively, utilized by attorneys in the law firm offices.

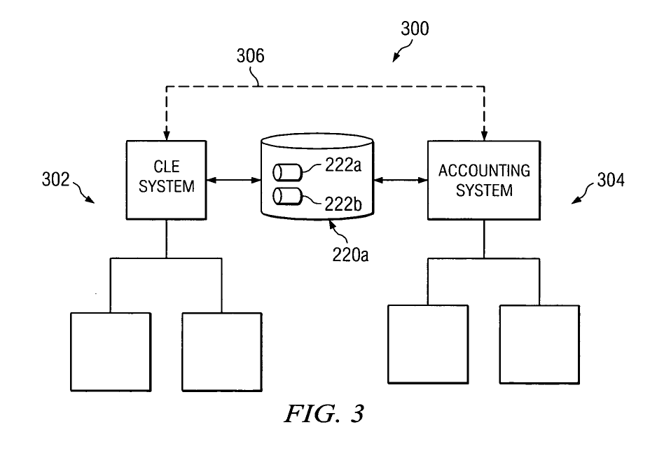

The server 202a may include a processor 212a that executes software 214a. The processor 212a may be in communication with memory 216a, an input/output (I/O) unit 218a, and a storage unit 220a. The storage unit 220a may store databases or data repositories 222a-222b thereon. The software 214a may include instructions for execution by the processor 212a for managing CLE requirements in accordance with the principles of the present invention. In addition, the software 214a may include instructions for managing budgets for the law firm. In one embodiment, the software 214a is composed of a CLE management software program and an accounting software package further described in FIG. 3. The server 202a may be physically located or utilized by the main office of the law firm.

A satellite office may utilize the server 202b. The server 202b may include a processor 212b that executes software 214b. The processor 212b may be in communication with memory 216b, I/O unit 218b, and storage unit 220b. The storage unit may store databases 224a-224b for storing information associated with the attorneys for CLE training in the satellite office. Each of the other satellite law offices may utilize the servers 202c and 202d, which may include the same or similar internal components as those of servers 202a and 202b, which are shown, accordingly. Each ofthe servers 202 may communicate via a network 230. The network 230 may be the Internet, intranet, or other communication system capable of communicating information between computing devices. The server 202a may communicate data packets 232a-232b containing information related to CLE training to another server 202b, as understood in the art. Similarly, the servers 202c and 202d may communicate information to the server 202a via data packets 234a-234b and 236a-236b, respectively, via the network 230.

In operation, the server 202a may execute the software 214a to enable the attorneys at the law firm to utilize their personal computers 204a and 208a, for example, either directly with the server 202a or indirectly via the network 230. The personal computers enable the attorneys and/or administrators of the attorneys to interface with the software 214a to request attendance at CLE classes for approval by a supervisor or management of the law firm, review CLE credits taken in the past, and manage budgets as dictated by the management of the law firm, for example.

FIG. 3 is a block diagram showing a software configuration 300 that may be executed by a processor of a server, such as one shown in FIG. 2, for interfacing a CLE management system 302 with an accounting system 304 utilized by a law firm. As understood in the art, both the CLE management system 302 and accounting system 304 may be software programs or modules operating on one server. Alternatively, multiple servers and/or computing devices maybe utilized to execute the CLE management system 302 and accounting system 304. The CLE management system may reside on a web server and be configured for remote access by a law firm and its attorneys. Whether the CLE management software 302 is operated by an internal server at a law firm or is operated by a web-based server of a third party, the accounting system 304 preferably is able to interface directly with the CLE management software 302, access data generated by the CLE management software 302, or import data generated by the CLE management software 302 so that the law firm management may properly manage their CLE training budgets. As shown, the storage device 228 (FIG. 2) having databases 222 or other data repositories may be in communication with the CLE management system 302 and accounting system 304.

The CLE management system 302 may generate data to be stored in the databases 222 while being utilized by attorneys in the law firm to manage and schedule CLE courses. The data generated may include available CLE courses, dates and times ofthe CLE courses, cost of the CLE courses, and other parameters. The accounting system 304 may access the databases 222 to account for estimated and actual attendance costs for attending CLE courses. Additionally, CLE budgets, expenses, and other financial information useful to a law firm may be stored in the databases 222 and accessed by the accounting program 304 in managing a CLE training program. Alternatively, rather than accessing the databases 222, the CLE management system 302 may communicate directly with the accounting system 304 as represented by the dashed communications line 306. In yet another embodiment, the accounting system 304 may have the CLE management system 302 integrated therein. It should be understood that other configurations are possible as known in the art.

TABLE II shows CLE tracking data that may be stored in the database 222 stored on the storage unit 220a. The CLE tracking data may include CLE requirements for all or particular states in which attorneys are licensed and CLE credit hours are being tracked. License dates that each attorney was licensed to practice in the particular state also may be maintained in the table. Other information related to the attorney with regard to the state, such as state bar number, state bar renewal date, state bar renewal fees, and other information may be stored in a database.

TABLE II further includes state CLE requirements that include total CLE credit hours and CLE credit hour requirements for specific topics. For example, in California (CA), the total credit hours are 25 and are composed of 19 general, 4 ethics, 1 elimination of bias, and 1 substance abuse. Each attorney for a firm must receive these CLE credit hours over a three-year period (see also TABLE I). Because attorneys are able to carry forward CLE credits from previous years, these “carry-over” credits are maintained in the database. The current CLE credits reflect CLE credit nours obtained during the current CLE credit period, and the total CLE credits reflect the total current CLE credit hours plus previous CLE credit hours. By maintaining the CLE credit hours, an attorney, and the firm, may monitor CLE credits for each state in which the attorney is licensed to ensure that he or she fulfills the CLE credit requirements. It should be understood that other data related to maintaining and monitoring of CLE credit hours may be additionally stored in the database. The data may be stored or represented in any suitable format as understood in the art.

TABLE II
Attorney CLE Credits

| | | | | | | PREVIOUS | | TOTAL CLE |
|---|---|---|---|---|---|---|---|---|
| | STATES | | | PERIOD | PERIOD | PERIOD CARRY | CURRENT | CREDITS |
| ATTOR- | LI- | LICENSE | STATE CLE | START | STOP | OVER CLE | CLE | (Current plus |
| NEY | CENSED | DATE | REQMT. | DATE | DATE | CREDITS | CREDITS | Previous) |
| Gregory | MA | May 1998 | 0.0 | N/A | N/A | 0.0 | 0.0 | 0.0 |
| Smith | | | | | | | | |
| Gregory | TX | May 1999 | 15.0 (Total) | Jul. 14, | Jul. 14, | 3.0 (Total) | 10.5 (Total) | 13.5 (Total) |
| Smith | | | 12.0 (General) | 2004 | 2005 | 3.0 (General) | 8.0 (General) | 11.0 (General) |
| | | | 3.0 (Ethics) | | | 0.0 (Ethics) | 2.5 (Ethics) | 2.5 (Ethics) |
| Leslie | CA | November | 25.0 (Total) | Jan. 01, | Dec. 31, | 0.0 (Total) | 3.5 (Total Current) | 3.5 (Total) |
| Burton | | 1995 | 19.0 (General) | 2004 | 2007 | 0.0 (General) | 1.0 (General) | 1.0 (General) |
| | | | 4.0 (Ethics) | | | 0.0 (Ethics) | 2.0 (Ethics) | 2.0 (Ethics) |
| | | | 1.0 (Elim. of Bias) | | | 0.0 (Elim. of Bias) | 0.0 (Elim. of Bias) | 0.0 (Elim. of Bias) |
| | | | 1.0 (Sub. Abuse) | | | 0.0 (Sub. Abuse) | 0.5 (Sub. Abuse) | 0.5 (Sub. Abuse) |
| William | LA | November | 12.5 (Total) | Jan. 01, | Dec. 31, | 4.0 (Total) | 12.5 (Total Current) | 16.5 (Total) |
| Fernandez | | 1990 | 10.5 (General) | 2005 | 2005 | 2.0 (General) | 7.0 (General) | 9.0 (General) |
| | | | 1.0 (Ethics) | | | 1.0 (Ethics) | 2.5 (Ethics) | 3.5 (Ethics) |
| | | | 1.0 (Profess. Resp.) | | | 1.0 (Profess. Resp.) | 3.0 (Profess. Resp.) | 4.0 (Elim. of Bias) |

TABLE IIIA includes an exemplary list of CLE courses available for attorneys of the firm to attend. Information related to each course may include course dates, course number, course title, course location, course CLE credit hours, course CLE topics, and whether the courses are internal, external, or online. The information may be stored in database 222b or other database available to the CLE management system 302 for access and display.

Other information related to the CLE courses, such as instructors, times, course size, specific location, transportation, login codes, or any other relevant course information, may be maintained in the database 222 and available for attorneys to access when reviewing CLE courses to attend. Additionally, information related to the law firm and related to the courses may be stored in the database. For example, attending attorneys, employee numbers, instructing attorneys, conference room(s), call-in codes, video conference availability, or other pertinent information may be stored and available for display, calendaring, and future notification. It should be understood that one or more databases may be utilized. The databases may be relational databases or configured otherwise as understood in the art.

TABLE IIIB includes the exemplary list of CLE courses for attorneys ofthe firm to attend as shown in TABLE IIIA, and further includes course fees and expenses. The course fees may include course registration fees and course materials, and the expenses may include the actual or estimated baseline expenses for airfare to travel to the city in which the course is being given, hotel room rates at which the course is being given, meals on a per diem or other basis, ground transportation, and other potential expenses. It should be understood that the course fees and expenses may be separated into as many itemized different categories as desired in accordance with the principles of the present invention.

TABLE IIIA
CLE Courses Information - Credits

| | | | | Internal/External/ | CLE Course | |
|---|---|---|---|---|---|---|
| CLE Course | CLE Course | | CLE Course | Online CLE | Credit | CLE Credit |
| Date | Number | CLE Course Title | Location | Credits | Hours | Topics |
| Jan. 15, 2005 | D1234567 | Wills 101 | — | Online | 1.0 | General |
| Feb. 05, 2005 | TR872525 | Trusts 101 | Dallas Office | Internal | 3.0 | General |
| Feb. 18, 2005 | PL001234 | Criminal 101 | San Francisco | External | 4.0 | General |
| Feb. 25, 2005-Feb. 27, 2005 | GB071466 | Intellectual Prop. 101 | Boston | External | 16.0 | Total |
| | | | | | 15.0 | General |
| | | | | | 1.0 | Ethics |
| Mar. 10, 2005-Mar. 11, 2005 | AS120463 | Franchise 101 | New York | External | 12.5 | Total |
| | | | | | 11.0 | General |
| | | | | | 1.5 | Ethics |
| Jan. 01, 2005-Dec. 31, 2005 | LS041838 | TAX 101 | — | Online | 1.5 | Total |
| | | | | | 1.0 | General |
| | | | | | 0.5 | Ethics |
| Apr. 01, 2005 | MT987654 | Fraud 101 | Washington, D.C. | Internal | 1.0 | General |
| Apr. 23, 2005 | AB543210 | Contracts 101 | San Diego | External | 1.0 | General |
| Jun. 20, 2005-May 23, 2005 | ST765123 | Real Estate 101 | Las Vegas | External | 15.0 | Total |
| | | | | | 13.0 | General |
| | | | | | 2.0 | Ethics |
| Jul. 14, 2005 | GS140766 | Intellectual Prop. 102 | Dallas Office | Internal | 1.0 | General |
| Aug. 12, 2005 | FJ033060 | Litigation 101 | — | Online | 2.0 | General |

TABLE IIIB
CLE Courses Information - Costs

| | | | | | Internal/External/ | | |
|---|---|---|---|---|---|---|---|
| CLE Course | CLE Course | CLE Course | | CLE Course | Online CLE | CLE | CLE |
| Start Date | End Date | Number | CLE Course Title | Location | Credits | Fees | Expenses |
| Jan. 1, 2005 | Dec. 31, 2005 | D1234567 | Wills 101 | — | Online | $250 | $0 |
| Feb. 05, 2005 | Feb. 05, 2005 | TR872525 | Trusts 101 | Dallas Office | Internal | $0 | $0 |
| Feb. 18, 2005 | Feb. 18, 2005 | PL001234 | Criminal 101 | San Francisco | External | $750 | $620 |
| Feb. 25, 2005 | Feb. 27, 2005 | GB071466 | Intellectual Prop. 101 | Boston | External | $2,000 | $1,250 |
| Mar. 10, 2005 | Mar. 11, 2005 | AS120463 | Franchise 101 | New York | External | $1,750 | $1,350 |
| Jan. 01, 2005 | Dec. 31, 2005 | LS041838 | Tax 101 | — | Online | $0 | $0 |
| Apr. 01, 2005 | Apr. 01, 2005 | MT987654 | Fraud 101 | Washington, D.C. | Internal | $0 | $0 |
| Apr. 23, 2005 | Apr. 23, 2005 | AB543210 | Contracts 101 | San Diego | External | $850 | $725 |
| Jun. 20, 2005 | Jun. 23, 2005 | ST765123 | Real Estate 101 | Las Vegas | External | $1,750 | $1,250 |
| Jul. 14, 2005 | Jul. 14, 2005 | GS140766 | Intellectual Prop. 102 | Dallas Office | Internal | $0 | $0 |
| Jan. 1, 2005 | Dec. 31, 2005 | FJ033060 | Litigation 101 | — | Online | $350 | $0 |

TABLE IV shows an exemplary summary of CLE budgets and costs for attorneys in a law firm. The budgets may be set by firm management. In one embodiment, the budgets are different for attorneys based on class year or other criteria, where, for example, more senior attorneys have higher budgets. The CLE costs may be a sum of actual CLE course fees and expenses to attend the courses. A detailed itemized list of budgets and costs (not shown) for each attorney may be maintained in the database 222b to show the attorney, supervisor, and firm management specifically where and how an attorney is spending money to attend CLE courses. An available budget value may be used to provide a financial assessment to the firm management to manage each attorney in accordance with budget targets. The information in TABLE IV may be stored in database 222b, related to other information stored in database 222b or elsewhere, and accessible to the CLE management system 302.

TABLE IV
CLE Budget Summaries

| | | | Actual CLE | Actual CLE | Actual | |
|---|---|---|---|---|---|---|
| | Class | CLE Budget | Courses | Courses | CLE Costs | Available |
| Attorney | Year | For Period | Fees | Expenses | Totals | Budget |
| Gregory | 1998 | $2,000 | $600 | $270 | $870 | $1,130 |
| Smith | | | | | | |
| Leslie | 1995 | $4,000 | $1,500 | $820 | $2,320 | $1,680 |
| Burton | | | | | | |
| William | 1990 | $4,000 | $2,200 | $2,580 | $4,780 | ($780) |
| Fernandez | | | | | | |

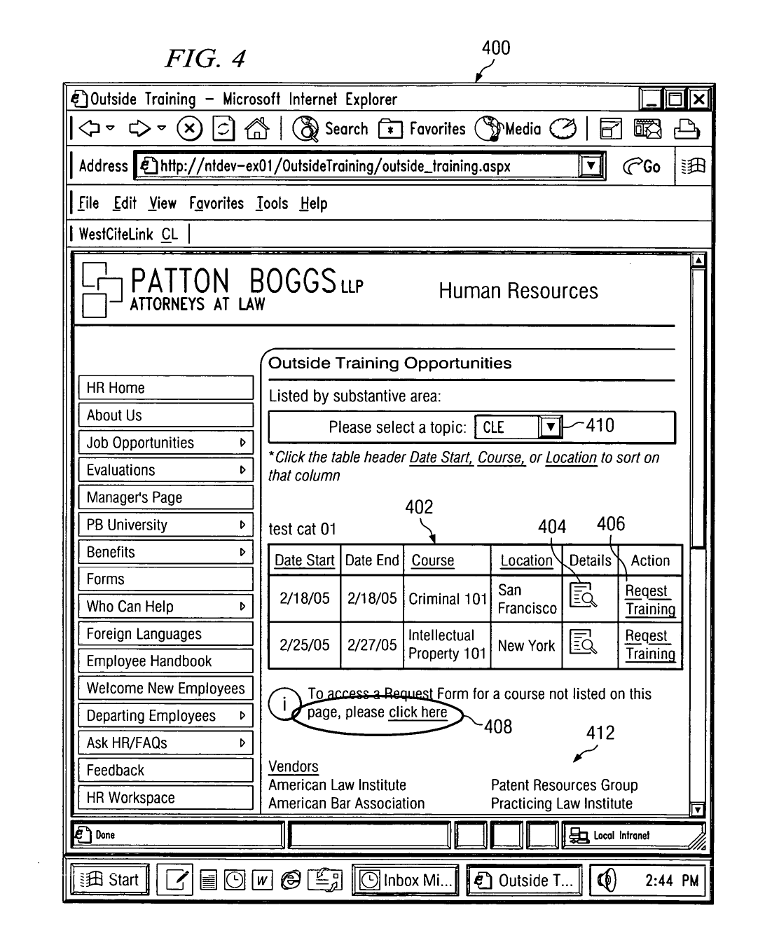

TABLE V shows an exemplary data table that includes course descriptions and links to CLE course providers' websites to enable attorneys to review a course. Attorneys using the CLE management system 302 may click on links to see the descriptions and websites (see FIG. 4). The information in Table V may be contained in database 222b or elsewhere.

TABLE V
CLE Description and Links

| CLE | CLE | CLE | | |
|---|---|---|---|---|
| Course | Course | Course | | |
| Date | Number | Title | CLE Course Description | Course website link |
| Jan. 15, 2005 | D1234567 | Wills 101 | Wills come alive as we look . . . | www.willsrus.com |
| Feb. 05, 2005 | TR872525 | Trusts 101 | Trusts are a man's best friend . . . | www.wetrust.com |
| Feb. 18, 2005 | PL001234 | Criminal 101 | It's a kill or be killed society . . . | www.criminals.com |

TABLE VI shows an exemplary data table that supports a CLE approval cycle that provides for managing course requests and approval or denial by supervisors. The information may be stored in database 222b or elsewhere. If configured as a relational database, the relationship or link may be the attorney name or employee number, for example. A department and supervisor may be included to identify who is to perform an initial or final approval or denial of a CLE course request by the associated attorney. An indicator of an approval and denial may be included to store whether the supervisor approves or disapproves the attorney's CLE course attendance request. It should be understood that other information associated with each attorney and the approval process may be included in this or a related database. For example, the law firm may use a second approval for CLE course requests where the costs are to exceed a certain amount, such as $1,000.

TABLE VI
CLE Course Request Approval

| | | | | CLE | CLE Course | Supervisor |
|---|---|---|---|---|---|---|
| | Employee | | | Course | Request | Approval/ |
| Attorney | Number | Department | Supervisor | Number | Date | Denial |
| Gregory | 5282 | Business | Jerry | D1234567 | Jan. 12, 2005 | Approved |
| Smith | | Transactions | Pamolo | | | |
| Leslie | 0050 | Bankruptcy | Dennis | TR872525 | Feb. 2, 2005 | Disapproves |
| Burton | | | Miller | | | |
| William | 6611 | Intellectual | Marty | PL001234 | Feb. 15, 2005 | Approved |
| Fernandez | | Property | Souza | | | |

TABLE VII provides a list of CLE courses previously taken by an attorney. The course history may be selectively displayed by the attorney to remember the names of the courses, dates each course was taken, name of the vendor, number of CLE credits each course provided, names of the instructors, or any other relevant information related to CLE course history of an attorney. A link to the course history may be provided by a soft-button or by an input field for a user to enter employee number, name, or any other identifier of an attorney.

TABLE VII
CLE Course History

| Dates | Course Name | CLE Credits | Vendor |
|---|---|---|---|
| Jan. 8, 2005 | Patents Are | 8 | IP |
| | Power | | Strategies |
| Aug. 12, 2005-Aug. | Patents for Fun | 16 | IP |
| 14, 2005 | and Profit | (2 ethics) | Strategies |

In addition, a course request history as shown in TABLE VIII may be provided to display a list of pending or decided upon requests to attend CLE courses. The course request history may provide the names of supervisors and administrators who are to approve or disapprove attending the CLE courses. By providing the course request history, an attorney may track the request to ensure it is timely acted.

TABLE VIII
Course Request History

| Request | Course | Course | Super- | Approval | Approval |
|---|---|---|---|---|---|
| Date | Number | Name | visor | Status | Date |
| Sep. 15, | 7253 | Trademarks | Welch | Approved | Sep. 15, |
| 2005 | | Forever | | | 2005 |
| Sep. 23, | 2153 | Copyrights | Welch | Pending | |
| 2005 | | and the Law | | | |

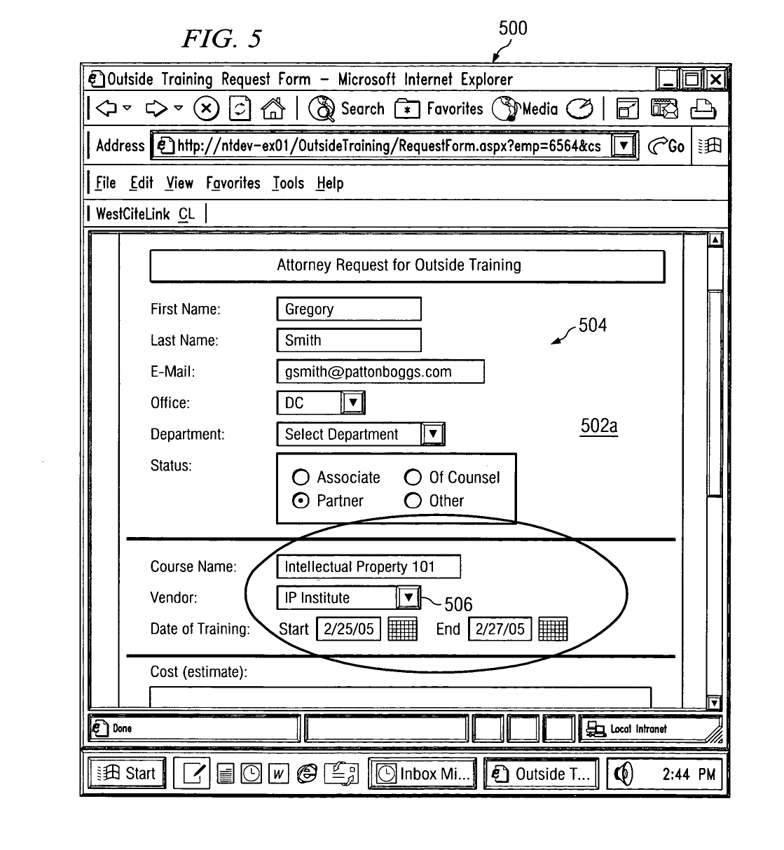

FIG. 4 shows an exemplary webpage 400 that may be utilized by a law firm to provide a list 402 of CLE training opportunities outside the law firm as exemplified in TABLES IIIA and IIIB and stored in a database, such as database 222b of FIG. 2. The list 402 may be configured as a table or otherwise. The webpage 400 may be a graphical user interface or other user interface as understood in the art. The webpage 400 may be hosted by an Internet server, intranet server, or other computing device to be accessible to attorneys, supervisors, and information controllers (e.g., CLE manager). The same or different webpage additionally may be utilized to provide a list of CLE training opportunities inside the law firm and online. The list 402 may include columns of information associated with each CLE course, including date start, date end, course name, location details, and action. An attorney accessing the webpage 400 may view additional details about a particular CLE course by selecting or “clicking” on an icon 404 or other indicia. In one embodiment, a number of links (not shown) to vendor websites may be provided to enable an attorney to select for view a vendor's website and available course listing(s). The additional details may include a full course description, instructor(s), course time(s), and other information associated with a CLE course. The attorney may request training by selecting a “Request Training” link 406 or other selectable element and a request for training form (see FIG. 5) may be generated with information about the course (e.g., course name, dates, registration fees, etc.) and presented to the attorney. In the case of an attorney wanting to take a course not included in the list 402, a blank training form may be generated for the attorney to enter the relevant course information by selecting another selectable link 408. A topic selection input field (e.g., pull-down menu) 410 may be provided to enable the attorney to select CLE training courses within a particular field of law, such as Intellectual Property.

In addition to courses being listed in a course list 402, a selectable list of vendors offering CLE courses may be displayed on the webpage 400. The list may be a list of links to webpages of the vendors as understood in the art. A link selected by an attorney may cause the webpage of the selected vendor to be displayed to provide a listing of CLE courses offered by the vendor with additional information of the courses.

FIG. 5 shows a webpage 500 of an exemplary training form 502. The training form 502 may include a number of data input fields 504, including text input fields, check boxes, radio buttons, selectable drop-down menus, and other data input fields as understood in the art. The data input fields 504 may be provided to describe the attorney, including first and last name, email address, office, department, and attorney status (e.g., associate, of counsel, partner, or other). Additional data fields describing the course, such as course name, vendor, training dates, etc., may be provided as well. If the attorney selects a “Request Training” link 406 (FIG. 4), then the training form may be automatically filled with information about (i) the attorney, if the particular attorney information is known by the system by the attorney logging in or otherwise, and (ii) the selected CLE course. The attorney may type in the course name and select the vendor. Alternatively, the course name and vendor may be automatically filled in by selecting a course (i.e., Request Training 406) on the webpage 400 (FIG. 4). In another embodiment, if the attorney wants to view other courses provided by a particular vendor, then the attorney may select a vendor from the pull-down menu 506, and a listing of all CLE courses from the selected particular vendor may be displayed to the attorney in a pop-up menu (not shown) or another pull-down menu (not shown). Accordingly, the list of other CLE courses from the vendor may be selectable.

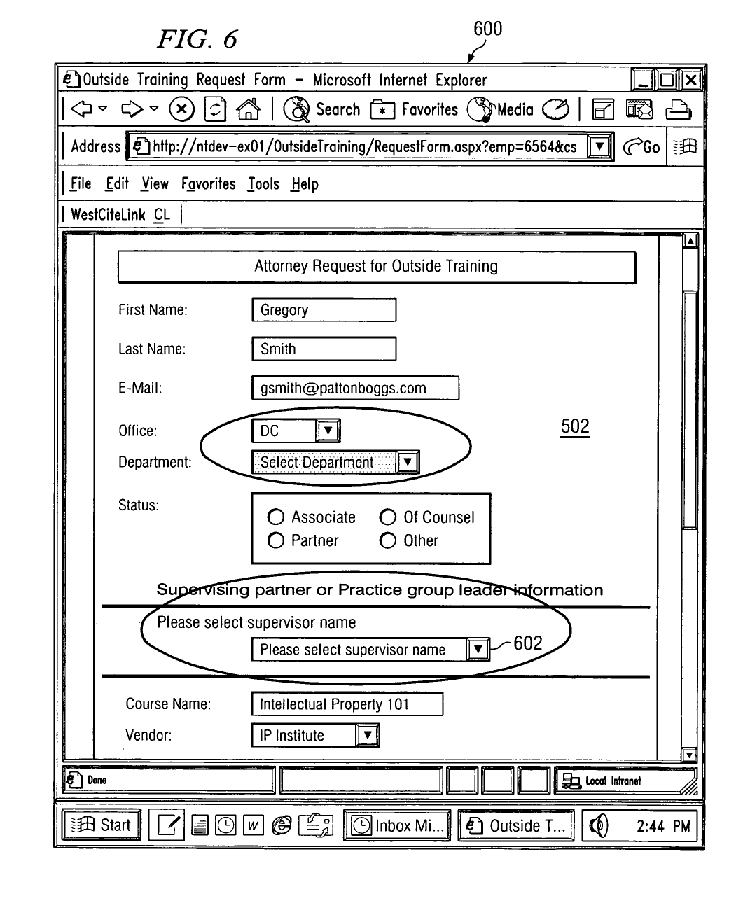

FIG. 6 illustrates a webpage 600 showing a continuation of the exemplary training form 502. In selecting a supervisor name, the attorney may select the department in which he or she works, thereby causing a short list of the different managers in that department to be available in supervisor drop-down menu 602. Alternatively, if the attorney does not select a department, then a complete list of all supervisors may be provided in the supervisor drop-down-menu 602.

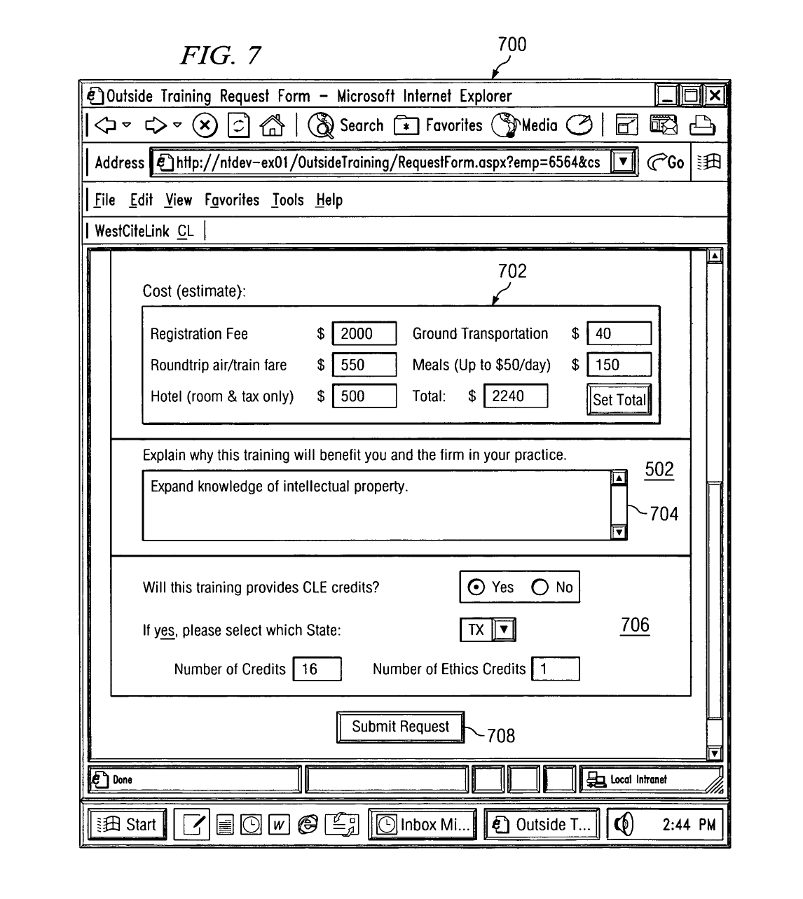

FIG. 7 illustrates a webpage 700 showing a continuation of the exemplary training form 502. The training form 502 may include a cost estimate section 702 for the CLE course. The cost estimate section may enable an attorney to input cost estimates, including registration fee, airfare, hotel, ground transportation, meals, etc. These cost estimates may alternatively be automatically included in the training form 502 based on the selected CLE course, location, special hotel rates, or other information maintained in a database or available for lookup by the CLE management system operating, interacting with, or receiving the information entered into the training form.

The training form 502 may also include a data entry field 704 that allows the attorney requesting a CLE training course to explain why the training CLE course being requested will benefit the attorney and the firm. This explanation provides the attorney's supervisor and/or management the ability to make a more educated decision as to whether to approve or reject the CLE training request. For example, if the attorney seeks to expand his practice into a specific area of the law that the attorney's supervisor approves or feels that the department could utilize, the supervisor will be more inclined to approve the CLE course. However, if the attorney seeks to take a course outside his or her area of specialty, then the supervisor may be inclined to reject the CLE training request unless the attorney is able to explain why he or she thinks that the CLE course will benefit his or her practice and the firm.

The CLE training form 502 may further include a CLE credits portion 706 that enables the attorney to enter whether CLE credits are available, how many, for which state, and specific topics to which the credits are to be applied (e.g., ethics). It should be understood that, if the attorney selects the CLE course from the list of CLE courses (see FIG. 4), the CLE credits information may automatically be filled in by the CLE management system.

Once the attorney has completed filling in the training form 502, the attorney may select a “Submit Request” button 708 or other submission element to submit the information entered. A verification may automatically be made by a software routine (not shown), such as an applet as understood in the art, operating the training form 502. If there is a data entry field that requires an input and has not been filled in, then the attorney may be requested to enter information into the data entry field. In addition, an indicator, such as a stop sign or other symbol, may be displayed on the webpage 700. In one embodiment, a symbol may be placed next to the data entry field(s) that require information. Alternatively, the data entry field(s) that require submission may be highlighted and a message may be written to alert the attorney that additional information is to be entered before the CLE request may be submitted. The information submitted may be stored and communicated to the attorney's supervisor for approval. The communication maybe an email or other communication to alert the supervisor of the request.

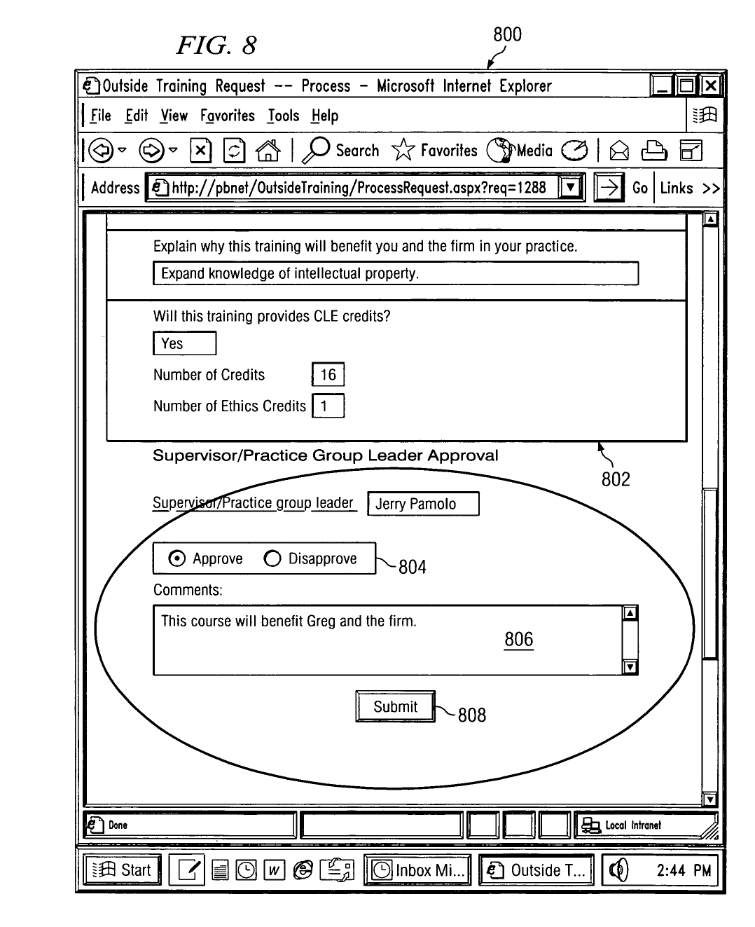

FIG. 8 illustrates a webpage 800 showing an approval screen 802 that is sent to the selected supervisor to approve or disapprove the CLE training request. The approval screen 802 may be separate or extended from a training form used by the attorney to request CLE training to show the supervisor the information entered by the attorney. The information submitted by the attorney to request training preferably is displayed in a form that cannot be edited by the supervisor. The supervisor may select whether to approve or disapprove the CLE request via a radio button or other selection field. In addition, the supervisor may enter text into a text box 806 to explain why the attorney is being approved or disapproved. The supervisor's input may be communicated to management for final approval and/or to the requesting attorney for feedback. Once the supervisor has completed approval or disapproval of the CLE request, then he or she may submit the information by selecting a “Submit” button 808. The information may be stored and a message sent to management for final approval. The message may be an email or other communication sent to a manager in charge of final approval of CLE requests.

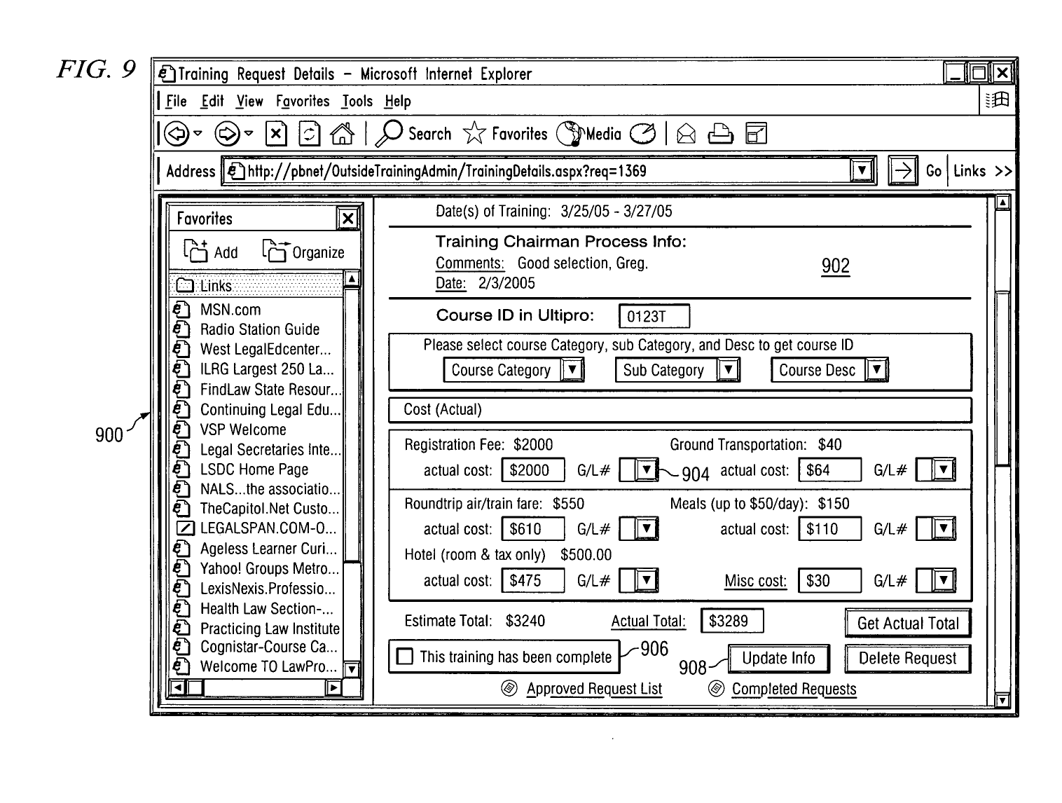

FIG. 9 shows a user interface 900 that is used for a final accounting of the CLE training of the attorney. The user interface 900 may be utilized by a manager, such as a CLE training manager or accounting person, to review the estimated costs and the actual costs for attending a CLE training course. The user interface 900 may be a website or other interface that enables the manager to inspect the costs to verify that the actual costs were close to the estimated costs, assign the different costs to general ledger accounts (G/L #) using a pull-down menu 904 or other input field, and complete the transaction by selecting a check box 906. Once reviewed and completed, the manager may finalize the accounting process by selecting an “Update Info” button 908 or other selection tool.

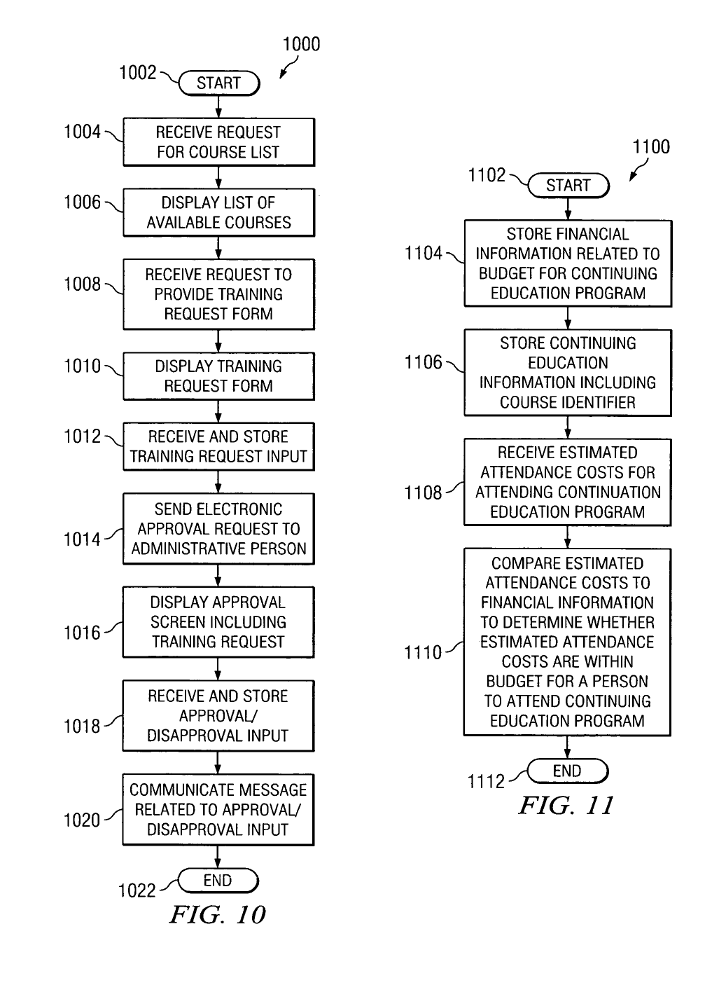

FIG. 10 shows a block diagram describing an exemplary process 1000 for enabling attorneys to submit training requests to management to attend a CLE course. The process 1000 starts at step 1002. At step 1004, a request for a course list is received. The request may be received from an attorney via a local area network or a wide area network, such as the Internet, at a server (e.g., server 202a of FIG. 2) or other computing device. Alternatively, if the course list is resident on a computer being operated by the attorney and is currently storing the course list, the request may be local to that computer. In response to the request being received, the course list is displayed on a screen being viewed by the attorney at step 1006. At step 1008, a request to provide a training request form may be received in response to the attorney viewing the course list and selecting or submitting a request for a training request form. In response, a training request form or screen is displayed on the screen being viewed by the attorney at step 1010.

The attorney may input or supplement input to the training request form and submit the training request information. At step 1012, the training request input may be received and stored by a computing system, such as a server being operated by a CLE administrator. At step 1014, an electronic approval request may be sent to an administrative person, such as a direct supervisor of the attorney, CLE administrator, or firm management. The electronic approval request may be sent in the form of an email or instant message. Alternatively, the administrative person may utilize a software program to access the training request input being sent electronically. At step 1016, an approval screen including the training request from the attorney to attend a particular CLE course is displayed to the adminstrative person. The administrative person may approve or disapprove of the CLE training request being displayed, and at step 1018 the approval/disapproval input is received and stored. A message related to the approval/disapproval input may be communicated to the attorney for notification as to whether his or her CLE training request was approved. The process ends at step 1022.

FIG. 11 shows a block diagram of an exemplary process 1100 for managing a continuing education program. In one embodiment, the continuing education program is a continuing legal education program or course. The process 1100 starts at step 1102. At step 1104, financial information related to a budget for a continuing education program may be stored. At step 1106, continuing education information including a course identifier is stored. At step 1108, estimated attendance costs for attending the continuing education program is received. A comparison may be made between the estimated attendance costs and the financial information of the continuing education program to determine whether the estimated attendance costs are within budget for a person to attend the continuing education program. If there is a difference between the estimated attendance costs and budget (e.g., the estimates are over the budget), then a supervisor may elect to disapprove the request. If, for example, there is a discrepency between the two, then a supervisor or manager may review the discrepency further. In one embodiment, the discrepency may be set to ten percent (10%) or another level optionally set by the supervisor. A notification of the difference may be made to the supervisor. The notification may be made by an electronic message, such as an email or other electronic message. The comparison may be performed automatically, semi-automatically, or by simply viewing the financial information being displayed next to the estimated attendance costs. The attendance costs may include course registration fees, travel expenses, and other miscellaneous expenses to attend a continuing education program. It should be understood that the same or a similar comparison maybe made using actual expenses after an attorney attends a CLE course.

One feature that the CLE management system 302 may utilize is a sophisticated in-house calendar. The purpose of the calendar is to provide a calendar that shows attorneys the training classes in-house (in each office) and to support attorney registration and training delivery.

The in-house calendar may utilize the following features:

0.0 Curriculum Model

0.1 Curriculum Model for each department available for user look up on-line
0.2 List of courses recommended for each associate by year at the firm
   1.0 Calendar of Classes
1.1 Capability to post title, date, and time of classes offered to attorneys
1.2 Daily/Monthly/Yearly Calendar view
1.3 Drop-down list of courses being offered in each regional office and for all offices
1.4 Provide link to detailed course description
1.5 Provide field to indicate CLE credit, if any
1.6 Indicate in which state CLE credit is being awarded
   2.0 Invitations
2.1 Generate custom invitations
2.2 Capability to identify intended audience
   2.2.1 Status: Associates, Partners, Of Counsel, Paralegals
   2.2.2 Experience Level: 4^{th} and 5^{th} year associates
   2.2.3 Department: Business, Litigation, IP, Public Policy
   2.2.4 Location: DC, VA, Denver, Dallas
2.3 Capability to extend invitation to second, third, and fourth tier audiences (i.e., all Business Associates; Business and Litigation Associates in DC and VA; Partners and Associates in all offices)
   3.0 Registration and Approval Process
3.1 Attorneys able to register on-line for a class with the click of a button
3.2 Associate requests approval from Supervisor for training
3.3 Training to be approved by Supervising Partner (same process as Outside Training Page)
3.4 Upon approval from Supervising Partner, automatic placement of class on registrant's MS Outlook calendar
   4.0 Reminders
4.1 Automatic generation of email reminders
4.2 Capability to set timing of reminders (two pays prior, one day prior, day of class)
4.3 On-line instructions for class registration
   5.0 Sign up Sheet
5.1 Generate a sign-in sheet from registrants
   6.0 Evaluation Form
6.1 Generate Standard Evaluation Form
   6.1.1 Customize with name of individual class
   6.1.2 Evaluation Summary Sheet
   6.1.3 Automatic email of evaluation form to participants after the course
      7.0 Certificates of Attendance Forms
7.1 Customized with name, date, hours of course
7.2 Filled in with name of attendee
   8.0 Administration Portion
8.1 Type in calendar information
8.2 Instructions
8.3 Manage folders for each class (Class name, date, time, description of the course, identified audience, invitation hierarchy, who RSVP'd, who attended, number of evaluations received, and summary of evaluations.)
   9.0 Instructions
9.1 How to register for a class
9.2 Administrator Instructions: How to add classes, update calendars, identify audiences, and summarize evaluations.
   10.0 CLE Accreditation
10.1 On-line application for CLE in states where firm has offices
10.2 Notification to attorneys when CLE accreditation has been awarded
   11.0 Reporting
11.1 Attorney In-House Calendar
   11.1.1 Course Title
   11.1.2 Course Date and Time
   11.1.3 Description of course
   11.1.4 Hours attended
   11.1.5 Instructors and titles
   11.1.6 Drop-down list to select for all, and each regional office
   11.1.7 Drop-down list to select time frame (month, year)
11.2 Attendance list
   11.2.1 Course Title, Date, and Time
   11.2.2 Hours attended
   11.2.3 Who RSVP'd
   11.2.4 Who Attended
   11.2.5 Associate Year
   11.2.6 Office Location
   11.2.7 Drop-down list to select for all, and each regional office
   11.2.8 Drop-down list to select time frame (month, year)
11.3 Evaluation Summary
   11.3.1 Total attendees; total evaluations received
   11.3.2 Summary of responses; points for course

By utilizing the features listed above for the in-house calendar, attorneys are able to find in-house CLE training and learn about the practices of other attorneys in the firm. It should be understood that the calendar may be extended to cover external and online training as well in accordance with the principles of the present invention.

While the above description and drawings are directed to a continuing legal education program to be utilized by law firms, it should be understood that the principles of the present invention may be utilized to facilitate any education or training program. For example, accounting firms may utilize the principles of the present invention for managing training programs for accountants working in those firms.

The previous description is of at least one embodiment for implementing the invention, and the scope of the invention should not necessarily be limited by this description. The scope of the present invention is instead defined by the following claims.

We claim:

1. A product for administering and tracking an attorney training program, said product comprising:
instructions for directing a processing unit to:
receive a request for a course list;
in response to the request, display a list of available courses;
receive a training form input that a training request form is to be provided;
in response to the training form input, display a training request screen;
receive and store a training request input via the training request screen showing a training request form;
responsive to the training request input, sending an electronic approval request to an administrative person;
displaying an approval screen, including the training request input on an administrator display;
receive and store an approval/disapproval input; and
communicate a message related to the approval/approval input; and
a media readable by the processing unit that stores the instructions.

2. The product as in claim 1, further including instructions for directing the processing unit to:
receive a selection of a particular course on the course list; and
responsive to the selection, display the selected particular course on the training request screen.

3. The product as in claim 1, further including instructions for directing the processing unit to:
receive a details input requesting details of a course on the course list; and
responsive to said details input, establish a link to a server of the vendor of the course.

4. The product as in claim 1, wherein the communication of a message includes sending an email.

5. The product as in claim 1, further including instructions for directing the processing unit to:
display a selectable list of course vendors; and
responsive to a vendor being selected, displaying a website of the vendor to display courses offered by the vendor.

6. The product as in claim 5, further including instructions for directing the processing unit to:
receive a request to display a history of courses taken by an attorney; and
display courses taken by the attorney.

7. The product as in claim 1, further including instructions for directing the processing unit to:
receive an identification input identifying a particular attorney; and
responsive to said identification input, display an identification of said particular attorney on the training request screen.

8. The product as in claim 7, wherein the instructions for sending an electronic approval request includes instructions for directing the processing unit to send the electronic approval request to the supervisor of the particular attorney.

9. The product as in claim 7, further including instructions for directing the processing unit to:
provide a selectable list of departments in which the particular attorney works;
in response to a selected department, provide a selectable list of supervisors within the selected department; and
in response to receiving a selected supervisor, store the selected department and supervisor with the training request input.

10. The product as in claim 1, further including instructions for directing the processing unit to:
receive a request to display a history of courses taken by an attorney; and
display courses taken by the attorney.

11. A method for administering and tracking an attorney training program, said method comprising:
receiving a request for a course list;
in response to the request, displaying a list of available courses;
receiving a training form input that a training request form is to be provided;
in response to the training form input, displaying a training request screen;
receiving and storing a training request input via the training request screen showing a training request form;
responsive to the training request input, sending an electronic approval request to an administrative person;
displaying an approval screen including the training request on an administrator display;
receiving and storing an approval/disapproval input; and
communicating a message related to the approval/disapproval input.

12. The method as in claim 11, further comprising:
receiving a selection of a particular course on the course list; and
responsive to the selection, displaying the selected particular course on the training request screen.

13. The method as in claim 11, further comprising:
receiving a details input requesting details of a course on the course list; and
responsive to said details input, establishing a link to a server of the vendor of the course.

14. The method as in claim 11 wherein said communicating a message includes sending an email.

15. The method as in claim 11, further comprising:
displaying a selectable list of course vendors; and
responsive to a vendor being selected, displaying a website of the vendor with information related to courses offered by the vendor.

16. The method as in claim 11, further comprising:
receiving a request to display training history taken by an attorney; and
responsive to the training history request, displaying training courses taken by the attorney.

17. The method as in claim 11, further comprising:
receiving an identification input identifying a particular attorney; and
responsive to said identification input, displaying an identification of said particular attorney on the training request screen.

18. The method as in claim 17, further comprising sending an electronic approval request which includes sending the electronic approval request to the supervisor of the particular attorney.

19. The method as in claim 17, further comprising:
providing a selectable list of departments in which the particular attorney works;
in response to a selected department, providing a selectable list of supervisors within the selected department; and
in response to receiving a selected supervisor, storing the selected department and supervisor with the training request input.

20. The method as in claim 11, further comprising:
receiving a request to display a history of courses taken by an attorney; and
displaying courses taken by the attorney.

21. An electronic system for administering and tracking an attorney continuing legal education (CLE) training program, said system comprising:
an electronic input device for producing input signals;
a display;
an electronic memory storing a list of CLE courses, course vendors, and a list of attorneys; and
an electronic processor communicating with said memory and said display and responsive to the input signals to:
direct said display to display said list of courses and said list of course vendors;
store a record of CLE course credits associated with each of the attorneys in said memory;
receive a course selection for an attorney in said list of attorneys;
generate a supervisor approval request including said course selection; and
communicate said supervisor approval request to a supervisor of said attorney.

22. The system as in claim 21 wherein the electronic processor is further responsive to the input signals and to said selection to display said selected course.

23. The system as in claim 21 wherein the electronic processor is further responsive to the input signals to:
receive a details input requesting details of a course on said course list; and
responsive to said details input, establish a link to a server of the vendor of said course.

24. The system as in claim 21 wherein the electronic processor is further responsive to the input signals to communicate the supervisor approval request as an email.

25. The system as in claim 21 wherein the electronic processor is further responsive to the input signals to:
display a selectable list of vendors offering the CLE courses; and
in response to a vendor being selected, display a website of the selected vendor to display a listing of CLE courses offered by the selected vendor.

26. The system as in claim 25 wherein the electronic processor is further responsive to the input signals to:
receive a request to display training history of an attorney; and
responsive to the training history request, display courses taken by the attorney.

27. The system as in claim 21 wherein the electronic processor is further responsive to input signals to:
receive an identification input identifying a particular attorney; and
responsive to said identification input, display an identification of said particular attorney on a training request screen.

28. The system as in claim 27 wherein the electronic processor is further responsive to input signals to:
provide a selectable list of departments in which the particular attorney works;
in response to a selected department, provide a selectable list of supervisors within the selected department; and
in response to receiving a selected supervisor, storing the selected department and supervisor with the training request input.

29. The system as in claim 21 wherein the electronic processor is further responsive to input signals to:
receive a request to display a history of courses taken by an attorney; and
display courses taken by the attorney.

30. A system for managing a continuing education program, said system comprising:
a computing system including:
a storage unit storing:
financial information related to a budget for the continuing education program; and
continuing education information including a course identifier; and
a processing unit executing instructions to cause said processing a unit to:
receive estimated attendance costs for attending the continuing education program; and
compare the estimated attendance costs to the financial information of the continuing education program to determine whether the estimated attendance costs are within a budget for a person to attend the continuing education program.

31. The system according to claim 30 wherein the continuing education program is a continuing legal education program.

32. The system according to claim 30 wherein the estimated attendance costs include a registration fee.

33. The system according to claim 32 wherein estimated attendance costs further include estimated travel costs.

34. The system according to claim 30 wherein the instructions further cause said processing unit to:
provide an actual expense form for attending a continuing legal education program; and
store actual expense information in response to receiving the actual expenses entered into the actual expense form.

35. The system according to claim 34 wherein the instructions further cause the processor to:
compare the actual expenses with the estimated attendance costs; and
generate a notification if the actual expenses are greater than ten percent (10%) different than the estimated attendance costs.

36. The system according to claim 34 wherein the instructions further cause the processor to:
compare the actual expenses with the estimated budget costs; and
generate a notification if the actual expenses are greater than ten percent (10%) different than the estimated budget costs.

37. A method for managing a continuing education program, said method comprising:
storing on an electronic storage device:
financial information related to a budget for the continuing education program; and
continuing education information including a course identifier; and
receiving estimated attendance costs for attending the continuing education program; and
comparing the estimated attendance costs to the financial information of the continuing education program to determine whether the estimated attendance costs are within a budget for a person to attend the continuing education program.

38. The method according to claim 37 wherein the continuing education program is a continuing legal education program.

39. The method according to claim 37 wherein the estimated attendance costs include a registration fee.

40. The system according to claim 39 wherein estimated attendance costs further include estimated travel costs.

41. The system according to claim 37, further comprising:
providing an actual expense form for attending a continuing legal education program; and
storing actual expense information in response to receiving the actual expenses entered into the actual expense form.

42. The system according to claim 41, further comprising:
comparing the actual expenses with the estimated attendance costs; and
generating a notification if the actual expenses are greater than ten percent (10%) different than the estimated attendance costs.

43. The method according to claim 41, further comprising:
comparing the actual expenses with the estimated budget costs; and
generating a notification if the actual expenses are greater than ten percent (10%) different than the estimated budget costs.
